(19) United States
(12) Patent Application Publication
(10) Pub. No.: US 2025/0282241 A1
(43) Pub. Date: Sep. 11, 2025

(54) AUTOMATED DECOUPLED CHARGER FOR ELECTRIFIED VEHICLE

(71) Applicant: FCA US LLC, Auburn Hills, MI (US)

(72) Inventors: Yi Ju, Shanghai (CN); Zhongwei Lu, Shanghai (CN); Dawei Li, Shanghai (CN); Xujin Ling, Shanghai (CN)

(21) Appl. No.: 18/599,784

(22) Filed: Mar. 8, 2024

(51) Int. Cl. B60L 53/35; B60L 53/16; B60L 53/18; B60L 53/62; H02J 7/00

(52) U.S. Cl. CPC B60L 53/35; B60L 53/16; B60L 53/18; B60L 53/62; H02J 7/0042

(57) ABSTRACT

A vehicle charging system includes a charging base, a cable arm, a charging cable, a controller and a vehicle charge connector. The controller is configured to determine whether a decoupling condition has been satisfied and communicate a decoupling signal in response thereto. The vehicle charge connector is configured to be electrically coupled to a vehicle charging port of the electrified vehicle during a charging event. The vehicle charge connector includes a charger body and an actuator. The charger body has a male extension portion extending therefrom. The actuator is movably disposed on the charger body and is configured to move from a retracted position to a deployed position upon receipt of the decoupling signal. Movement of the actuator to the deployed position causes a forcing surface on the actuator to push against a surface on the electrified vehicle and urge the vehicle charge connector away from the vehicle charging port.

### FIELD

The present application relates generally to electrified vehicles and, more particularly, to an electrified vehicle charging system having a charging cable coupling assembly that automatically detaches from the electrified vehicle.

### BACKGROUND

An electrified vehicle (hybrid electric, plug-in hybrid electric, range-extended electric, battery electric, etc.) includes at least one battery system and at least one electric motor. Typically, the electrified vehicle could include a high voltage battery system and a low voltage (e.g., 12 volt) battery system. In such a configuration, the high voltage battery system is utilized to power at least one electric motor configured on the vehicle and to recharge the low voltage battery system via a direct current to direct current (DC-DC) convertor. Electrified vehicles require an electrical charging cord, such as a Type 2/Level 2 portable charger, that electrically couples between a power source and the vehicle battery. Typically, when the electrified vehicle has reached a desired charge status, a user manually decouples an electrical charging connector associated with the electrical charging cord from the vehicle and returns it to the charging system. Accordingly, while such electrified vehicle charging connections do work for their intended purpose, there exists an opportunity for improvement in the relevant art.

### SUMMARY

In accordance with one example aspect of the invention, a vehicle charging system for an electrified vehicle is provided. The vehicle charging system includes a charging base, a cable arm, a charging cable, a controller and a vehicle charge connector. The charging base houses electrical charging components. The cable arm is movably coupled to the charging base. The charging cable is configured to communicate current from the electrical charging components to the electrified vehicle. The controller is configured to determine whether a decoupling condition has been satisfied and communicate a decoupling signal in response thereto. The vehicle charge connector extends from the charging cable and is configured to be electrically coupled to a vehicle charging port of the electrified vehicle during a charging event. The vehicle charge connector includes a charger body and an actuator. The charger body has a male extension portion extending therefrom. The actuator is movably disposed on the charger body and is configured to move from a retracted position to a deployed position upon receipt of the decoupling signal. Movement of the actuator to the deployed position causes a forcing surface on the actuator to push against a surface on the electrified vehicle and urge the vehicle charge connector away from the vehicle charging port.

In addition to the foregoing a motor is disposed on the charging base and mechanically coupled to the cable arm. The motor configured to move the cable arm from an outward charging position to a retracted position.

In addition to the foregoing, the controller communicates a signal to the motor to move the cable arm to the retracted position subsequent to communicating the decoupling signal.

In addition to the foregoing, the charging base further comprises a magnet, wherein the magnet is configured to magnetically couple the vehicle charge connector thereat.

In addition to the foregoing, the controller determines that a decoupling condition has been satisfied based on a vehicle charge is complete.

In addition to the foregoing, the controller determines that a decoupling condition has been satisfied based on an unsafe condition being detected

In addition to the foregoing, the controller determines that a decoupling condition has been satisfied based on an indication that the electrified vehicle has shifted out of park.

In addition to the forgoing, the charger body includes a track assembly, wherein the actuator translates along the track assembly from the retracted position to the deployed position.

In addition to the forgoing, the vehicle charging port further defines a female receiving portion that receives the male extension portion of the charger body during the charging event.

According to another example aspect of the invention, a method for automatically decoupling a vehicle charge connector from an electrified vehicle is provided. The method includes determining, at a controller provided in a charging base that houses electrical charging components, that a charge condition is enabled; determining, at the controller, whether a decoupling condition has been satisfied; and communicating, based on a decoupling condition being satisfied, a decoupling signal to an actuator on the vehicle charge connector, the actuator being caused to move from a retracted position to a deployed position upon receipt of the decoupling signal, wherein movement of the actuator to the deployed position causes a forcing surface on the actuator to push against a surface on the electrified vehicle and urge the vehicle charge connector away from the vehicle charging port.

In addition to the forgoing, the method further includes communicating a signal to a motor disposed in the charging base, the motor mechanically coupled to a cable arm, whereby the motor moves the cable arm from an outward charging position to a retracted position.

In addition to the forgoing, the signal is communicated to the motor subsequent to communicating the decoupling signal.

In addition to the forgoing, the method includes magnetically coupling the vehicle charge connector to a magnet disposed on the charging base subsequent to the cable arm moving to the retracted position.

In addition to the forgoing, the decoupling condition is satisfied based on an indication that a vehicle charge is complete.

In addition to the forgoing, the decoupling condition is satisfied based on an indication that an unsafe condition is detected.

In addition to the forgoing, the decoupling condition is satisfied based on an indication that the electrified vehicle has shifted out of park.

In addition to the forgoing, moving the actuator from the retracted position to the deployed position comprises translating the actuator along a track.

Further areas of applicability of the teachings of the present disclosure will become apparent from the detailed description, claims and the drawings provided hereinafter, wherein like reference numerals refer to like features throughout the several views of the drawings. It should be understood that the detailed description, including disclosed embodiments and drawings references therein, are merely exemplary in nature intended for purposes of illustration only and are not intended to limit the scope of the present disclosure, its application or uses. Thus, variations that do not depart from the gist of the present disclosure are intended to be within the scope of the present disclosure.

### BRIEF DESCRIPTION OF THE DRAWINGS

FIG. 1 is a perspective view of an electrified vehicle charging system having a charging cable coupling assembly that automatically detaches from the vehicle according to the principles of the present disclosure;

FIG. 2A is a front perspective view of a vehicle charge connector that selectively couples to an electrified vehicle, the vehicle charge connector shown in a coupling position with an actuator in a retracted or at-rest position according to an example of the present disclosure;

FIG. 2B is a front perspective view of the vehicle charge connector of FIG. 2A shown in a decoupling position with the actuator in a deployed position according to an example of the present disclosure;

FIG. 3 is a front perspective view of the electrified vehicle charging system shown with a user initially coupling the vehicle charge connector to an electrified vehicle to initiate a charging event;

FIG. 4A is a side view of the vehicle charge connector of FIG. 2A shown in a connected position with the electrified vehicle;

FIG. 4B is a side view of the vehicle charge connector of FIG. 2B shown in a decoupled position subsequent to the actuator moving to the deployed location;

FIG. 5 is a front perspective view of the electrified vehicle charging system shown subsequent to a decoupling signal communicated to the actuator to unplug the vehicle charge connector from the electrified vehicle, wherein an arm automatically returns the charging cable toward the charging base;

FIG. 6 is a front perspective view of the electrified vehicle charging system shown with the vehicle charge connector magnetically attached to a magnet on the charging base; and

FIG. 7 is a logic flow chart illustrating steps for automatically detaching the vehicle charge connector from an electrified vehicle subsequent to receiving a decoupling signal and returning the vehicle charge connector to the charging base according to examples of the present disclosure.

### DESCRIPTION

As previously discussed, there exists an opportunity for improvement in the art of charging electrified vehicles. For example, electrified vehicles are generally required to electrically connect a cable between the vehicle and a power source for charging the high-voltage battery of the electric vehicle (A/C charging). Typically, a user physically takes the vehicle charge connector from a vehicle charging station and couples the vehicle charge connector to their vehicle. When the desired charge is completed, the user physically decouples the vehicle charge connector from their vehicle and returns it to the vehicle charging station. The act of manipulating the vehicle charge connector and associated electrical cable that extends between the vehicle charge connector and the vehicle charging station can be cumbersome. In this regard, many electrical cables are heavy and awkward to maneuver.

The present disclosure provides a vehicle charging system that incorporates a charging cable coupling assembly that automatically detaches from the vehicle. Upon indication of a decoupling signal, the vehicle charge connector automatically decouples from the vehicle. Furthermore, a cable arm that orients the charging cable retracts from a charging position to a stowed position bringing the charging cable and the vehicle charge connector back toward the charging base and generally away from the vehicle. A magnet on the charging base magnetically attracts the vehicle charge connector to an attached position on the charging base. The automatic decoupling alleviates the need for the vehicle user to manually disconnect the vehicle charge connector from the vehicle and return it to the charging base. As described herein, the decoupling signal that triggers the decoupling can result from a variety of conditions such as, but not limited to, an indication that charging has reached the desired limit, an unsafe condition, unauthorized use of the charging system, emergency use of a connected vehicle.

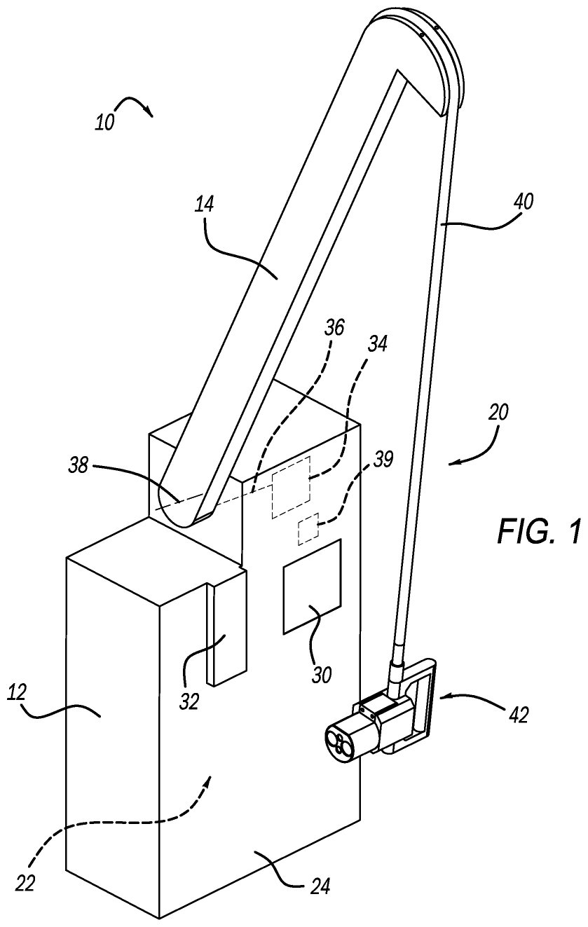

Referring now to FIG. 1, vehicle charging system constructed in accordance to examples of the present disclosure is shown and generally identified at reference numeral 10. The vehicle charging system 10 generally includes a charging base 12, a cable arm 14 and a charging cable coupling assembly 20. The charging cable coupling assembly 20 generally comprises a charging cable 40 and a vehicle charge connector 42. The charging cable coupling assembly 20 is configured to communicate current from the charging base 12 and into an electrified vehicle during a charging event.

The charging base 12 generally houses electrical charging components 22 within a housing 24. A user interface panel 30 and a magnet 28 are arranged on the housing 24 of the charging base 12. A motor 34 drives a shaft 36 operably coupled to the cable arm 14. As will be described in greater detail herein, rotation of the shaft 36 causes the cable arm 14 to rotate around an axis 38. The user interface panel 30 can receive instructions from a user including charging amount requests and, in some examples, payment information. A controller 39 is provided in the charging base 12 and is configured to communicate with the electrical charging components 22, the user interface panel 30, the motor 34 and the vehicle charge connector 42. It will be appreciated that the vehicle charge connector 42 is generically represented but can be configured to be plug types specific for use with any vehicle charging situation (e.g., Type 1, 110V; Type 2, 220V).

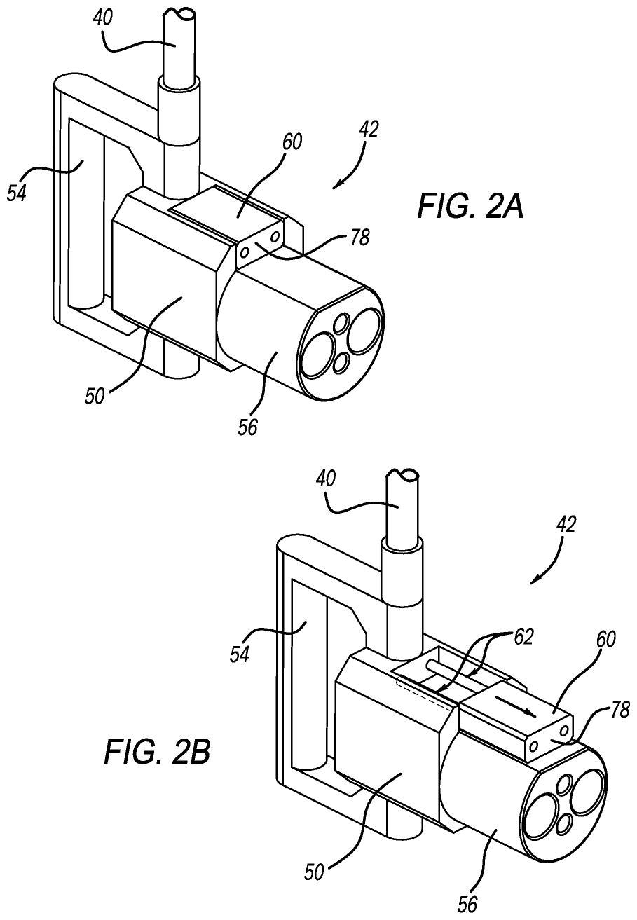

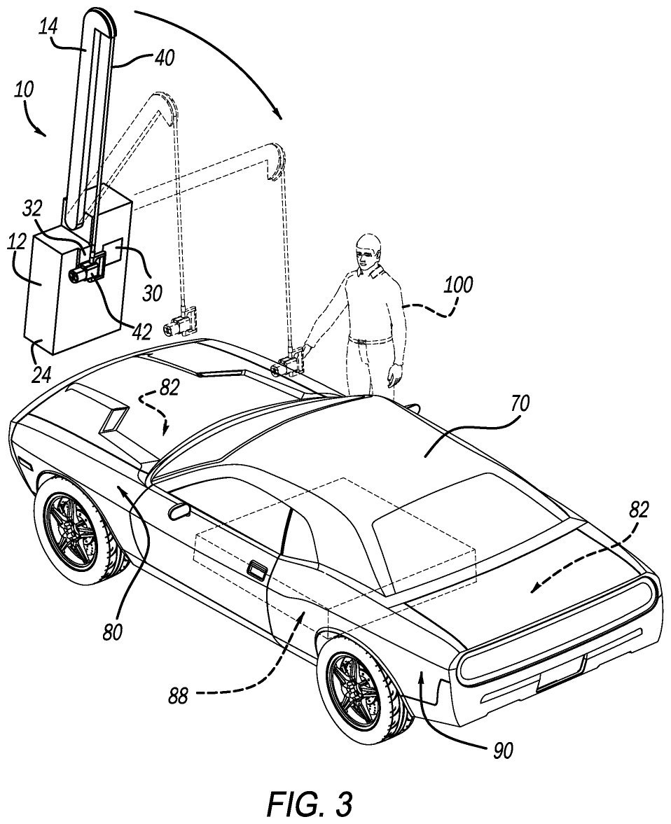

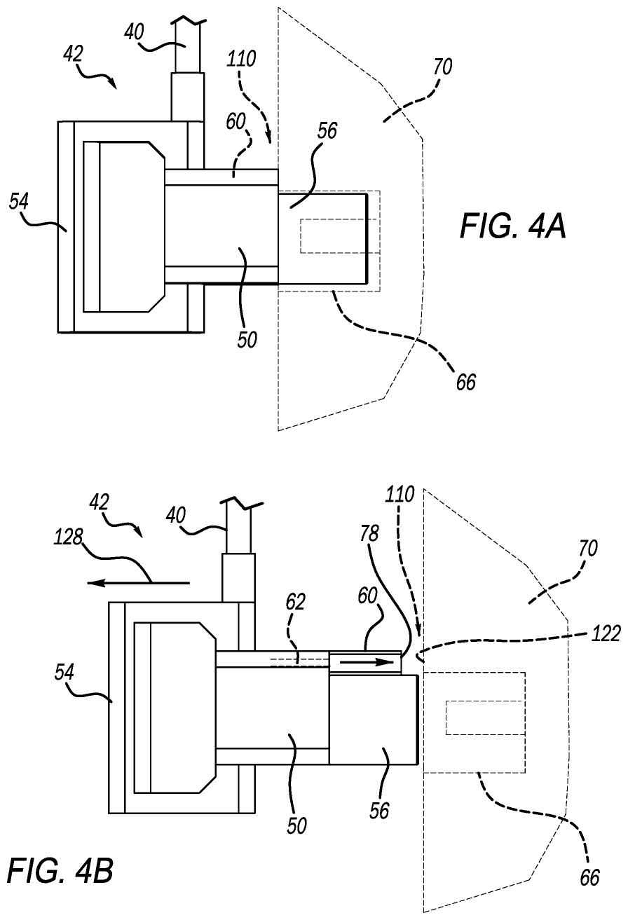

With additional reference now to FIGS. 2A-4B, additional features of the charging cable coupling assembly 20 will be described. The charging cable coupling assembly 20 includes a charging cable 40 and a vehicle charge connector 42. The vehicle charge connector 42 includes a charger body 50, a charger handle portion 54 and a male extension portion 56. The male extension portion 56 is configured to be received by a female receiving portion 66 (FIGS. 4A-4B) provided on an electrified vehicle 70 (FIG. 3).

An actuator 60 is movably disposed on the charger body 50 and configured to translate from a retracted or at-rest position (FIG. 2A) to a deployed position (FIG. 2B) upon receipt of a decoupling signal from the controller 39. The actuator 60 can be configured to translate along a track assembly 62. In examples, the track assembly 62 can be configured as posts however other configurations are contemplated. As identified above, translation of the actuator 60 from the retracted position shown in FIG. 2A to the deployed position shown in FIG. 2B causes the vehicle charge connector 42 to automatically detach from the vehicle 70. As will be described below, the detaching is facilitated by engagement of a forcing surface 78 configured on a distal end of the actuator 60 with an engaging surface on the vehicle 70.

Upon indication of a decoupling signal, the vehicle charge connector 42 automatically decouples from the vehicle 70. As described herein, the decoupling signal that triggers the actuation of the actuator 60 from the at-rest position (FIG. 2A) to the deployed position (FIG. 2B) can result from a variety of conditions including an indication that charging has reached the desired limit, an unsafe condition such as a short circuit, unauthorized use of the charging system, a vehicle shift from park, and emergency use of a connected vehicle.

The electrified vehicle 70 generally includes an electrified powertrain 80 comprising one or more electric motors 82. The electric motor(s) 82 are powered by a high voltage battery system 88 (e.g., a 16 kilowatt-hour (kWh) lithium-ion battery pack) and generate drive torque that is transferred to a driveline 90 of the vehicle 70. The high-voltage battery system 88 according to the example shown is configured as a 48 volt battery system (1 kilowatt-hour) although other voltages are contemplated.

With particular reference now to FIGS. 3-4B, an exemplary charging sequence will be described. At the outset, a user 100 can retrieve the vehicle charge connector 42 from the vehicle charging system 10. In examples, the vehicle charge connector 42 can be magnetically coupled to the magnet 32 (see solid line location of the vehicle charge connector 42). The user 100 can interact with the user interface panel 30 to enter the requested charge parameters (e.g., charge amount desired, time desired, or any parameter). It is further appreciated that in some examples where the vehicle charging system is in a public area, the user interface panel 30 can also receive payment information from the user 100.

The user then moves the vehicle charge connector 42 off of the magnet 32 and locates the vehicle charge connector 42 into a vehicle charging port 110 (FIG. 4A) provided on the vehicle 70. In examples, the vehicle charging port 110 defines the female receiving portion 66. In this regard, the male extension portion 56 is inserted by the user 100 into the female receiving portion 66 of the vehicle charging port 110 (see charging or connected position FIG. 4A). In the charging position, the vehicle charge connector 42 is electrically and mechanically connected to the vehicle charging port 110 for transferring current from the vehicle charging system to the battery 88 of the vehicle 70. Typically, during charging, the user 100 does not need to stand by the vehicle charge connector 42 and is generally free to return to the vehicle cabin or move away from the vehicle 70 entirely.

Once charging is complete (or other decoupling conditions described herein are met), the controller 39 sends a signal to the actuator 60 on the vehicle charge connector 42 causing the actuator 60 to move from the connected position (FIG. 4A) to the decoupled position (FIG. 4B). During movement of the actuator 60 from the connected position (FIG. 4A) to the decoupled position (FIG. 4B), the forcing surface 78 on the actuator 60 urges against an engagement surface 122 on the vehicle 70 resulting in the male insertion portion 56 to be forcibly retracted from the female receiving portion 66 and the vehicle charge connector 42 to move to the decoupled position (FIG. 4B). In examples, this action can additionally cause the vehicle charge connector 42 to move generally in a direction 128 away from the vehicle 70. It is appreciated that additional mechanical decoupling may also occur between the vehicle charge connector 42 and the vehicle charging port 110 during the movement of the actuator 60 to the decoupled position.

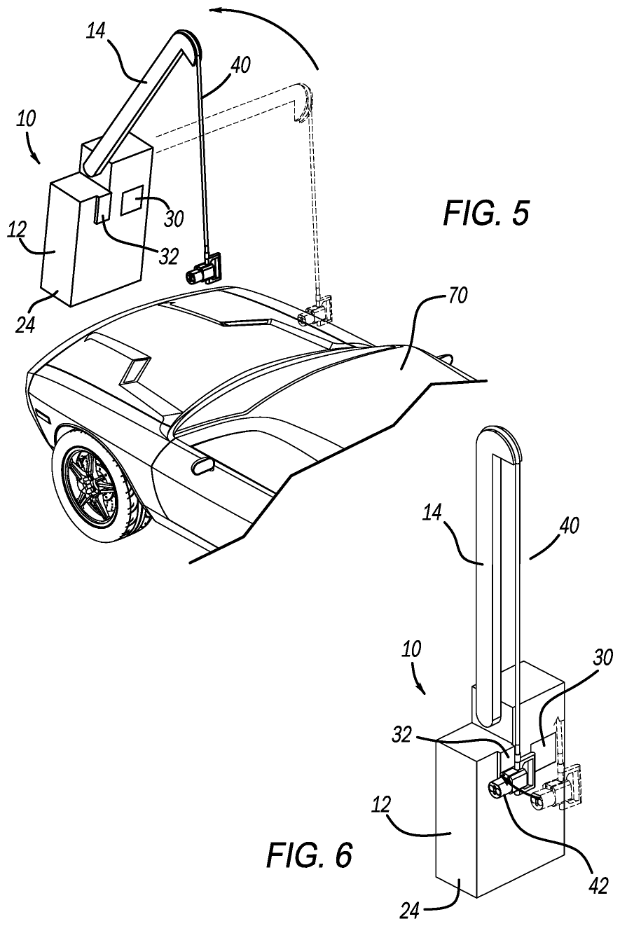

Once the actuator 60 moves to the decoupled position and the vehicle charge connector 42 is retracted from the vehicle charging port 110, the controller 39 sends a signal to the motor 34 to rotate shaft 36 causing the arm 14 to retract toward the charging base 12 (see FIGS. 5 and 6). The vehicle charge connector 42 is moved to a position proximate the magnet 32 such that the vehicle charge connector 42 is magnetically coupled to the magnet 32 (see solid line location of the vehicle charge connector 42, FIG. 6).

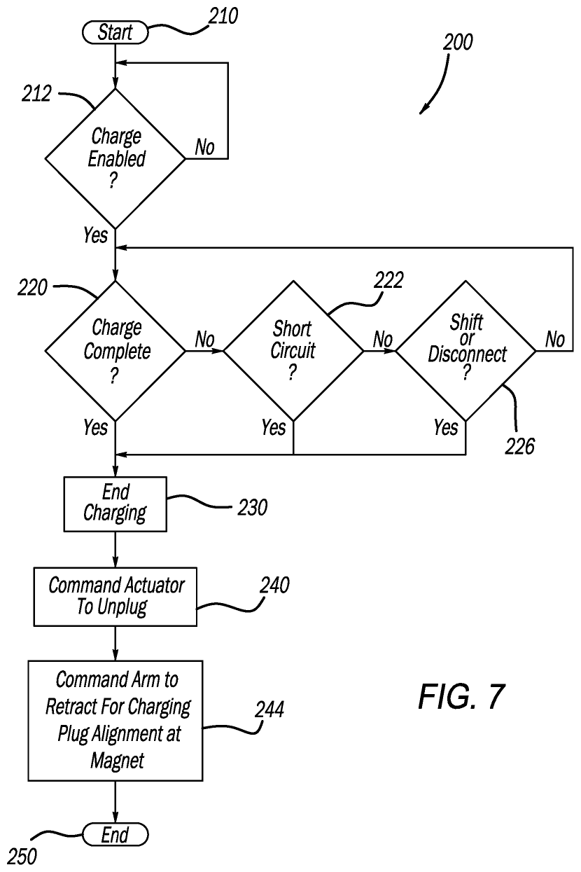

With reference to FIG. 7 a method of automatically decoupling the vehicle charge connector 42 from the electrified vehicle 70 is shown generally at reference 200. Control starts at 210. At 212 control determines whether a vehicle charge event has been enabled. If not, control loops to 212. If control determines that a vehicle charge event has started at 212, control determines whether a charge is complete at 220. A complete charge is used herein to denote a charging sequence has reached a requested state by a user such as a desired partial charge amount or reached a full charge. If yes, control proceeds to 230 where charging ends. Charging ending can be used to denote a conclusion of electrical current being communicated from the vehicle charging system 10 to the vehicle 70.

If control determines that charge is not complete at 220, control determines whether an unsafe condition exists, such as a short circuit at 222. If yes, control proceeds to 230. If control determines that an unsafe condition does not exist at 222, control determines whether the vehicle 70 has shifted out of park or other disconnect condition has been satisfied at 226. If yes, control proceeds to 230. If control determines that a shift or other disconnect condition has not been satisfied at 226, control loops to 220.

After charging has ended at 230, control communicates, at 240, a signal to the actuator 60 to move from the retracted position to the deployed position to unplug the vehicle charge connector 42 from the vehicle charging port 110. At 244 control commands the arm 14 to retract toward the charging base 12 (from the location shown in FIG. 5 back to the location shown in FIG. 6) where the vehicle charge connector 42 magnetically couples to the magnet 32.

It will be understood that the mixing and matching of features, elements, methodologies, systems and/or functions between various examples may be expressly contemplated herein so that one skilled in the art will appreciate from the present teachings that features, elements, systems and/or functions of one example may be incorporated into another example as appropriate, unless described otherwise above. It will also be understood that the description, including disclosed examples and drawings, is merely exemplary in nature intended for purposes of illustration only and is not intended to limit the scope of the present disclosure, its application or uses. Thus, variations that do not depart from the gist of the present disclosure are intended to be within the scope of the present disclosure.

What is claimed is:

1. A vehicle charging system for an electrified vehicle, the vehicle charging system comprising:
a charging base that houses electrical charging components;
a cable arm movably coupled to the charging base;
a charging cable configured to communicate current from the electrical charging components to the electrified vehicle;
a controller that is configured to determine whether a decoupling condition has been satisfied and communicate a decoupling signal in response thereto; and
a vehicle charge connector extending from the charging cable and configured to be electrically coupled to a vehicle charging port of the electrified vehicle during a charging event, the vehicle charge connector comprising:
a charger body having a male extension portion extending therefrom; and
an actuator movably disposed on the charger body, the actuator configured to move from a retracted position to a deployed position upon receipt of the decoupling signal, wherein movement of the actuator to the deployed position causes a forcing surface on the actuator to push against a surface on the electrified vehicle and urge the vehicle charge connector away from the vehicle charging port.

2. The vehicle charging system of claim 1, further comprising:
a motor disposed on the charging base and mechanically coupled to the cable arm, the motor configured to move the cable arm from an outward charging position to a retracted position.

3. The vehicle charging system of claim 2, wherein the controller communicates a signal to the motor to move the cable arm to the retracted position subsequent to communicating the decoupling signal.

4. The vehicle charging system of claim 1, wherein the charging base further comprises a magnet, wherein the magnet is configured to magnetically couple the vehicle charge connector thereat.

5. The vehicle charging system of claim 1, wherein the controller determines that a decoupling condition has been satisfied based on a vehicle charge is complete.

6. The vehicle charging system of claim 1, wherein the controller determines that a decoupling condition has been satisfied based on an unsafe condition being detected.

7. The vehicle charging system of claim 1, wherein the controller determines that a decoupling condition has been satisfied based on an indication that the electrified vehicle has shifted out of park.

8. The vehicle charging system of claim 1, wherein the charger body includes a track assembly, wherein the actuator translates along the track assembly from the retracted position to the deployed position.

9. The vehicle charging system of claim 1, wherein the vehicle charging port further defines a female receiving portion that receives the male extension portion of the charger body during the charging event.

10. A method for automatically decoupling a vehicle charge connector from an electrified vehicle, the method comprising:
determining, at a controller provided in a charging base that houses electrical charging components, that a charge condition is enabled;
determining, at the controller, whether a decoupling condition has been satisfied; and
communicating, based on a decoupling condition being satisfied, a decoupling signal to an actuator on the vehicle charge connector, the actuator being caused to move from a retracted position to a deployed position upon receipt of the decoupling signal,
wherein movement of the actuator to the deployed position causes a forcing surface on the actuator to push against a surface on the electrified vehicle and urge the vehicle charge connector away from the vehicle charging port.

11. The method of claim 10, further comprising:
communicating a signal to a motor disposed in the charging base, the motor mechanically coupled to a cable arm, whereby the motor moves the cable arm from an outward charging position to a retracted position.

12. The method of claim 11, wherein the signal is communicated to the motor subsequent to communicating the decoupling signal.

13. The method of claim 12, further comprising magnetically coupling the vehicle charge connector to a magnet disposed on the charging base subsequent to the cable arm moving to the retracted position.

14. The method of claim 10, wherein the decoupling condition is satisfied based on an indication that a vehicle charge is complete.

15. The method of claim 10, wherein the decoupling condition is satisfied based on an indication that an unsafe condition is detected.

16. The method of claim 10, wherein the decoupling condition is satisfied based on an indication that the electrified vehicle has shifted out of park.

17. The method of claim 10, wherein moving the actuator from the retracted position to the deployed position comprises translating the actuator along a track.
